(19) United States
(12) Patent Application Publication
(10) Pub. No.: US 2008/0313042 A1
(43) Pub. Date: Dec. 18, 2008

(54) USER DRIVEN SYSTEM FOR ENABLING ASSOCIATIVE ENDORSEMENT AND DISTRIBUTION OF BRANDING CAPSULES

(76) Inventor: Derek SHIELDS, Los Angeles, CA (US)

Correspondence Address: DALINA LAW GROUP, P.C., 7910 IVANHOE AVE. #325, LA JOLLA, CA, 92037, US

(21) Appl. No.: 12/139,410

(22) Filed: Jun. 13, 2008

Related U.S. Application Data
(60) Provisional application No. 60/943,840, filed on Jun. 14, 2007.

(51) Int. Cl. G06Q 30/00

(52) U.S. Cl. 705/14

(57) ABSTRACT

Building brand awareness that enables users to personally endorse and drive branded messages to a plurality of targets that have a high likelihood of being receptive to the message and associated branding. To ensure that the brand messaging is kept consistent with the desires of the advertiser a repository of brand capsules is available for driving users to select from. To propagate a brand capsule into the community the driving user selects the brand capsule from the repository and associates it with an anticipated event the driving user wishes to associate with the chosen brand. After identification of the targets the brand capsule is forwarded to the targets via a transport mechanism appropriate for carrying the encapsulated imagery and data to the target users. By sending out the brand capsule the driving user implicitly or explicitly endorses the brand by associating it with a personal event, message or request.

This application claims benefit of U.S. Provisional Patent Application Ser. No. 60/943,840 filed Jun. 14, 2007, which is hereby incorporated by reference.

### BACKGROUND OF THE INVENTION

1. Field of the Invention

Embodiments of the invention described herein provide interfaces and systems for enabling users to associate with and distribute branding capsules to others users using branded messages configured to build brand awareness amongst a target set of users known or invited by a driving user.

2. Description of the Related Art

Existing systems such as email or e-vite™ provide users with a way to send written messages to one another and/or invite a specific group of users to an event. However these existing communication systems lack brand integration with products or services that driving users might wish to promote or be associated with in connection with an activity or need of the driving user.

The problem most advertisers face is in delivering their message to people who are known to have an interest in a particular brand of product or service. Existing systems for distributing ads such as email have little ability to effectively distribute ads to users that fall within the appropriate demographic and wish to receive the ad itself. Indeed, the effectiveness of any particular advertising campaign today often requires using the services of a marketing company that analyzes and interprets large amounts of data to help define which demographic is relevant and should be considered for the development of an advertising campaign. This analysis is quite involved and typically takes an inefficient amount of time to complete. Moreover, relying on marketing research firms for online marketing negates much of the hope for improved productivity and efficiency from using online marketing in the first place. Much of the advertising dollars that are spent are spent reaching people that are irrelevant to the message being advertised.

Businesses continue to find better ways to market their products and services on the Internet. Traditional Internet advertising formats (banners, pop-ups, video rolls, spam email) while very popular are not tightly targeted at users that have an interest in what is being advertised. For many networked users, the term “annoying” comes to mind when describing Internet ads today. Hence there is a need for messaging systems that promote brands in a positive way that is context appropriate based on the communication.

### BRIEF SUMMARY OF THE INVENTION

One or more embodiments of the invention are directed to a system for building brand awareness that enables users to personally endorse and drive branded messages to a plurality of targets that have a high likelihood of being receptive to the message and associated branding. Each individual branding message takes the form of a brand capsule containing a message for the target user as well as imagery and optional functionality that further complements the branding message. To ensure that the brand messaging is kept consistent with the desires of the advertiser a repository of brand capsules each approved by the advertiser is available for driving users to select from. These brand capsules are prepared for specific events, activities or requests. To initiate a brand capsule into the community for propagation the driving user first selects the brand capsule from the repository and associates it with an anticipated event the driving user wishes to associate with the chosen brand. The messages available for selection are generally related to an activity, event, announcement or other information driving users might wish to broadcast to target users. Once a selection is made the user then identifies a set of one or more target users that the driving user wishes to provide with an instance of the brand capsule.

After identification of the target users the brand capsule is forwarded to the targets via a transport mechanism appropriate for carrying the encapsulated imagery and data to the target users for viewing and use. By sending out the brand capsule the driving user implicitly or explicitly endorses the brand by associating it with a personal event, message or request. Upon distribution the brand capsule enables users to associate a given event or activity with a brand by providing a message accompanied with user interfaces allowing users to co-brand personal messages or content with visual imagery and/or design features of design object (e.g., commercial icons, logos, and stock photos) in a way that reinforces the value of both personal and business identities. There is a viral nature to the method especially when users send out a co-branded advertising message through the platform configured to implement embodiments of the invention described herein.

The method for implementing the assembly and distribution of brand capsules makes use of web based technology components that facilitate collaboration and sharing between users, e.g., folksonomies, social networking sites, and wikis. The method may use any number of the following techniques but not limited to: cascading style sheets (CSS), interactive content or multimedia plugins (e.g., Flash), REST or XML APIs, Rich Internet Application techniques (e.g., Ajax-based), scripting language (e.g., Javascript), software solution stacks (e.g., LAMP), syndication and aggregation of data (e.g, RSS or Atom), use of folksonomies (e.g., tags or tagclouds), web application hybrids (e.g., mashups), weblog publishing, wiki software, and XHTML.

Using the platform enabled by the invention described herein advertisers or parties working on behalf of the advertisers submit brand capsules and create one or more digital media, for addition to the repository. Each brand capsule is designed to deliver a message to a recipient and to be used in a specific context that is relevant to the brand being promoted. A brand capsule that promotes a particular kind of alcohol for example, might be created as an invitation to go out to drinks.

Some level of customization with respect to brand capsules is permissible in that users may browse the library and select a brand capsule for personalization by modifying a pre-defined cell or zone. The driving user is allowed to disseminate the brand capsule as desired to further the message, event or action the driving users wishes to propagate to others. Because the user selected the branded object and may also select the desired recipients a level of person relevance and endorsement becomes part of the message that is distributed. Hence messages are personally relevant to the sender, recipient, and/or a community that both the driving and receiving users are part of by function of having common knowledge about one another's existence. The stronger the affinity between the chosen imagery and the users, the stronger the appeal, whether it be a famous actor promoting a new movie, or a logo from a popular video game. Hence there is a viral nature to the method, especially if the brand capsule is an event invitation or request for information that can be forwarded and re-forwarded to others.

### BRIEF DESCRIPTION OF THE DRAWINGS

The above and other aspects, features and advantages of the invention will be more apparent from the following more particular description thereof, presented in conjunction with the following drawings wherein:

FIG. 1 shows a block diagram illustrating components of a system for carrying out the viral advertising method in accordance with one or more embodiments of the invention.

FIG. 2 illustrates a sign in and user approval process according to one or more embodiments of the invention.

FIG. 3 illustrates process of submitting design object according to one or more embodiments of the invention.

FIG. 4 shows a flow diagram illustrating a method utilizing composition zones in accordance with one or more embodiments of the invention.

FIG. 5 shows a digital medium is provided to illustrate various embodiments of the invention.

FIG. 5B shows a digital cell can be associated with a composition zone.

FIG. 6 shows a flow diagram illustrating a viral advertising method of interacting with a user in accordance with one or more embodiments of the invention.

FIG. 7 illustrates a brand capsule containing digital imagery for promoting a new album.

FIG. 8 illustrates a brand capsule that a driving user sent for purposes of inviting others to watch an event (e.g., a basketball game) at an identified location.

FIG. 9 illustrates a brand capsule that a driving user might send to promote attending an event such as a fight.

FIG. 10 illustrates a brand capsule that a driving user sends to promote a service offered by the driving user and brands affiliated with the service itself.

FIG. 11 illustrates a brand capsule that relates to a driving user soliciting services or expertise about a particular product, service or other matter.

FIG. 12 illustrates a brand capsule related to an activity the driving user wishes to convey to a receiving user and invite the receiving user to attend.

FIG. 13 illustrates a brand capsule that relates to an activity organized by the driving user and provides links to a web site relevant to the activity.

FIG. 14 illustrates a brand capsule that serves as an invitation to a meeting at a coffee house.

FIG. 15 illustrates a brand capsule that serves as a personal note and solicitation for a charity or other organization that accepts donations.

FIG. 16 illustrates a brand capsule that promotes a service offered by a driving user.

FIG. 17 illustrates a brand capsule to an event that has a corresponding association with a commercial entity as a function of a registry.

### DETAILED DESCRIPTION

A user driven system for enabling associative endorsement and distribution of branding capsules is set forth herein. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

The term “digital media” as used herein refers to any form of digital media can be displayed on a user interface device. Digital media comprises at least one or any combination of image, text, and/or sound. Digital media may come in a form of, for example but not limited to, email message, icon, graphics, pictures, letterhead, postcard, business card, video, music and the like. Based on the disclosure provided herein, one of ordinary skill in the art will appreciate a myriad of non-digital media that can be made or converted from digital media, e.g., record digital media file on machine readable medium (e.g., CD, videotape, removeable drive, etc.), print out a hard copy form of digital media (i.e., onto paper), and the like.

The terms “social network” or “social networking” as used herein refers to any modes of communication that links user to one or more individual

The term “digital cell” as used herein refers to any portion of a digital or media production. Thus, as just one example, a digital cell can encompass one or more digital presentation, or a portion of a digital presentation of the digital media production. As another example, a digital cell can be a portion of a website, a portion of a digital document (e.g., email or image file), or a portion of video or audio production. In some cases, a digital cell can reflect the trim size and placement of available or user-editable composition. Based on the disclosure provided herein, one of ordinary skill in the art will recognize a myriad of digital production, and digital cells that can be associated therewith.

The term “composition zone” as used herein refers to any layout area. In some cases, such composition zones are associated with a corresponding digital cell, while in other cases a composition zone is independent of a digital cell. In yet other cases, the composition zones perform the function of both digital cell and the layout area. Composition zones can be used to contain one or more content objects that make up a layout such as user editable content in a digital letterhead or email postcard. Based on disclosure provided herein a number of composition zones and purposes thereof that can be utilized in accordance with embodiments of the invention.

The term “design object” as used herein refers to any style, theme, sound, attribute, image, video, etc., that may or may not be identified as an advertising or brand of business. The term “brand capsule” is used when a design object is created in a way that associates it with or makes use of a brand.

The term “business user” as used herein refers to any user who provides imagery and/or design feature for incorporation in digital products or is a representative for the owner of such imagery and/or design feature.

Development of a digital media incorporating design object for co-branding involves a number of entities, each applying their particular skill in concern to create an end digital product. For example, to develop a brand capsule or digital postcard incorporating one or more designed objects, a number of entities can be involved including graphic artists, production artists, authors, actors, editors, attorneys, suppliers, service providers, clients, advertisers, and/or the like. In some cases each of the entities involved in the development are employed by one company, however, in many cases a number of entities are third parties. For example, in many cases the media owners or owners of design objects are third parties that impose their own functions, rules and requirements with respect to how a brand capsule may be distributed.

Various embodiments of the invention provide systems and methods that facilitate a digital production workflow capable of providing driving users with capabilities to create digital products incorporating brand capsules as provided by others. For example, some embodiments of the invention provide a software system for producing a digital media. The software includes instructions executable by a microprocessor-based system to produce and disseminate a digital media. Each of the steps in the production process can be impacted by different entities with the commonality being that the end goal it to create a brand capsule that further promotes and extends a specific brand in connection with specific events which driving users may opt to personally endorse.

As just one example, a business user can build a brand capsule that comprises numerous design objects for distribution as digital media. Each brand capsule makes use of the brand but is created for use by third parties in connection with activities coordinated by the third party hosting or driving the event, message or activity. To allow these third parties or driving users to customize the brand capsule the capsule may contain a way for users to edit the capsule to make it applicable to their personally situation.

A user who provides the design object may allow the design object to be defined as or reduced to an extensible or semi-extensible digital form. As used herein, an extensible digital form is one that can be exported or re-purposed for any medium within a defined set of digital media. In contrast, a semi-extensible digital form is a form that is extensible to one or more medium within the defined set of digital media, but not to all of the defined set of media. Use of extensible and semi-extensible digital forms allow a user to design within one space (whether digital media specific or digital media independent), and the re-purpose a creation to one or more digital media. Thus, a user can treat, for example, languages as simply text and images as simply pictures.

The term “re-purposing” as used herein is used in its broadest possible sense to mean any modification of a design, composition zone, layout, content object or other from one format to another. This can include modification from a digital media independent format to a digital media specific format and/or from one digital media specific format to another digital media specific format. In some cases, re-purposing a design object enjoys some degrees of extensibility into different digital forms for incorporation into different digital media as they allow for personalization by users and/or relatively inexpensive digital media production.

It is contemplated that users may re-purpose digital creation into non-digital media including print type medium, video recordable medium, audio recordable medium, and the like.

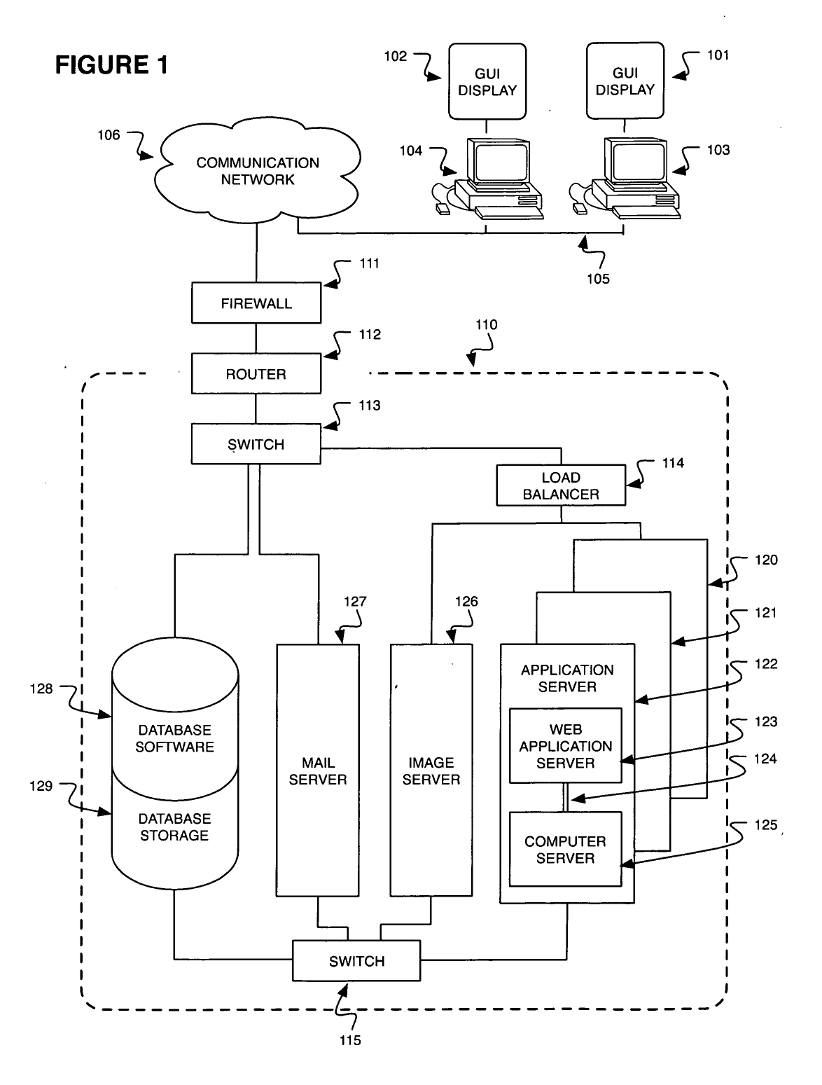

FIG. 1 illustrates the general architecture of a system that operates in accordance with an embodiment of the invention. As shown in FIG. 1, a plurality of graphical user interface (GUI) displays 101 & 102 are presented on a plurality of user interface devices 103 & 104 connected to an apparatus 110 via a communication network 106. The user interface device may be any device capable of presenting data, including, but not limited to, computers, mobile telephones (e.g., “smart” phones), television sets or hand-held personal digital assistants (PDA).

In an embodiment, the communication network 106 is a partially public or a wholly public network such as the Internet. The communication network 106 may also be a private network or include one or more distinct or logical private networks (e.g., virtual private networks or wide area networks). Additionally, the communication links 105 to and from the communication network 106 can be wired or wireless (i.e., terrestrial- or satellite-based transceivers). As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services.

As described herein, the exemplary public network of FIG. 1 is for descriptive purposes only. Although the description may refer to terms commonly used in describing particular communication network such as the Internet, the description and concepts equally apply to other public and private computer networks, including systems having architectures dissimilar to that shown in FIG. 1. For example, and without limitation thereto, the system of the present invention can find application in public as well as private networks, such as a closed university social system, or the private network of a company.

The apparatus 110 is connected to the Internet through a router 112 and a switch 113. As is well known in the relevant arts, routers forward packets between networks. The router 112 forwards information packets between the apparatus 110 and devices 103 & 104 over the Internet. A load balancer 114 balances the traffic load across multiple mirrored servers 120, 121, 122 and a firewall 111 provides protection from unauthorized access to the apparatus 110. The switch 113 may act as a gatekeeper to and from the Internet. The components appearing in the apparatus 110 refer to an exemplary combination of those components that would need to be assembled to create the infrastructure in order to provide the tools and services contemplated by an embodiment of the invention. As will be apparent to one skilled in the relevant arts, all of components “inside” of the apparatus 110 may be connected and may communicate via a wide or local area network (WAN or LAN).

The apparatus 110 includes an application server 122 or a plurality of application servers 122. The application server 122 comprises a web application server 123 and a computer server 125 that serves as the application layer of the embodiment of the invention. Yet another server is the image server 126, which has the purpose of storing and providing digital images to other components of the apparatus 110. Also included is a mail server 127, which sends and receives electronic messages to and from devices 103 & 105. The mail server 127 supports common email protocols, such as the Simple Mail Transfer Protocol (SMTP) and the Post Office Protocol, version 3 (POP3). Also included are the database software 128 and a database 129.

The Web application server 123 is a system that sends out Web pages in response to Hypertext Transfer Protocol (HTTP) requests from remote browsers (i.e. users of the apparatus 110). That is, the Web server 123 provides the GUI 101 & 102 to users of the system in the form of Web pages. These Web pages sent to the user's device 103 & 104 would result in GUI screens 101 & 102 being displayed.

The apparatus 110 also includes a second switch 115 that allows the components of the apparatus to be interconnected in a local area network (LAN) or a wide area network (WAN). Thus, data can be transferred to and from the various components of the apparatus 110.

As will be appreciated by those skilled in the relevant art(s), this configuration of router 112 and switch 113 is flexible and can be omitted in certain embodiments. Additional routers 112 and/or switches 113 can also be added.

The application server 122, the database(s) 128, 129 and the mail server 127 are shielded from the public Internet through the firewall 111. The firewall 111 is a dedicated gateway machine with special security precaution software. It is typically used, for example, to service Internet connections and dial-in lines and protects the cluster of more loosely administered network elements hidden behind it from external invasion. Firewalls are well known in the relevant art(s).

As will be appreciated by those skilled in the relevant art(s), the inclusion of the firewall 111 is flexible and can be omitted in certain embodiments. Additional firewalls 111 can also be added.

The computer server 125 may include a central processing unit (CPU), a random access memory (RAM) temporary storage of information, and a read only memory (ROM) for permanent storage of information. Computer server 125 may be generally controlled and coordinated by an operating system software. The operating system controls allocation of system resources and performs tasks such as processing, scheduling, memory management, networking and I/O services, among things. Thus, the operating system resident in system memory and executed by CPU coordinates the operation of the other elements of the apparatus 110.

Although the description of the computer server 125 may refer to terms commonly used in describing particular computer servers, the description and concepts equally apply to other processing systems, including systems having architectures dissimilar to that shown in FIG. 1.

Also included is an inter-process communications protocol 124 (ICP), a set of rules for marshalling and un-marshalling parameters and results. This is the activity that takes place at the point where the control path in the calling and called process enters or leaves the ICP domain. The ICP 124 is essentially a set of rules for encoding and decoding information transmitted between multiple processes.

As will be appreciated by those skilled in the relevant art(s), the inclusion of the ICP is flexible and can be substituted or omitted in certain embodiments.

The apparatus 110 may also include the image server 126 or a plurality of image servers that manage(s) digital photographs and other human viewable images. The image server 126 may be configured separately from the web server 123. This configuration may increase the scalability of the apparatus 110. Alternatively, the web server 123 and the image server 126 can be configured together. Examples of image formats that can be managed by the image server 126 include, but are not limited to, Graphical Interchange Format (GIF), Joint Photographics Experts Group (JPEG), or Portable Network Graphics (PNG) or Tagged Image File (TIF).

The mail server 127 is a repository for e-mail messages received from the Internet. It also manages the transmission of electronic messages (“electronic mail” or “e-mail”). The mail server 127 consists of a storage area, a set of user definable rules, a list of users and a series of communication modules. Its typical purpose in an embodiment of the invention is the storage and distribution of e-mail messages to the Internet.

The databases 128, 129 store software, descriptive data, digital images, system data and any other data item required by the other components of the apparatus. The databases may be provided, for example, as a database management system (DBMS), and object-oriented database management system (ODBMS), a relational database management system (e.g. DB2, ACCESS etc.), a file system or another conventional database package. Thus, the databases 128 & 129 can be implemented using object-oriented technology or via text files. Further, the databases 128 & 129 can be accessed via a Structured Query Language (SQL) or other tools known to one of ordinary skill in the art.

As will be appreciated by one skilled in the art, the infrastructure to support the function of the embodiments of the invention can comprise any number of configurations. The infrastructure can be scaled to handle more or less data load and components may be disparate from one another or where possible combined to better facilitate delivery of data for use to support one or more embodiments of the invention.

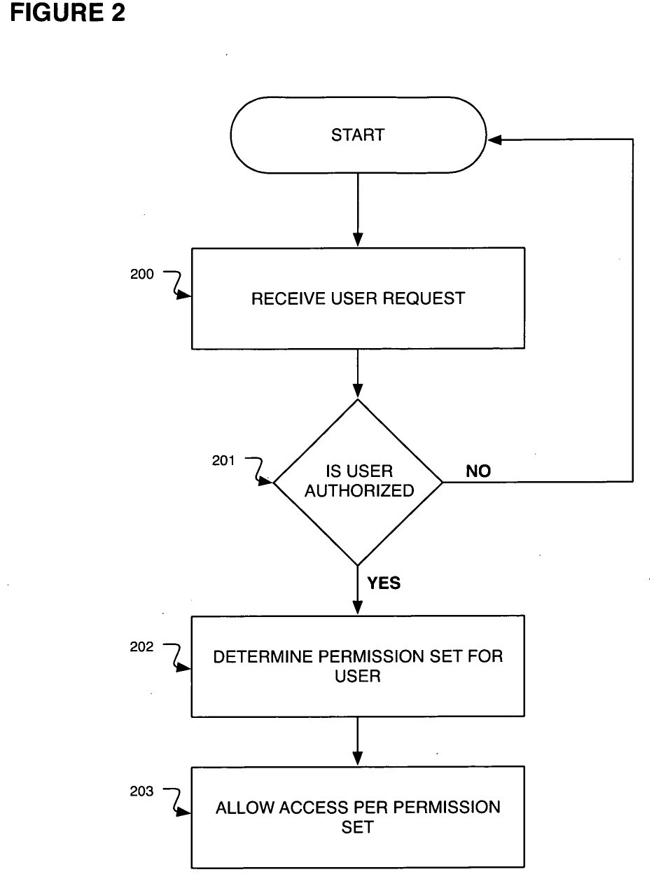

In one or more embodiment of the invention, the system allows a user to sign in the apparatus from a remote user interface device and access brand capsules stored in the database. FIG. 2 illustrates a sign in and user approval process according to one or more embodiments of the invention. At step 200, the system receives a request from a user to access a database of the system. At decision point 201, system determines whether the user is authorized to access the databases. If the user is not authorized, the server denies the requested access. If the user is authorized, then at step 202 the server determines the permission set for this particular user. The permission set for each authorized user may be set up by a system administrator. This permission set can include, for example, authority to view all or only certain design objects and/or brand capsules, authority to approve the selection of digital cell or digital media template for a particular co-branding purpose, modify the design object, and so forth. The permission set may be coupled to user account. At step 203, the system allows an authorized user to access design objects, digital cells, digital media, composition zones, product documentation, brand capsules, and associated files per user permission set. The database is searchable so that an authorized user can search for brand capsules by product, category, event, description, text in comment fields, and so forth, per user permission set. In an embodiment using a standards compliant web browser that supports HTML, the user can view and/or manipulate the brand capsule imagery and/or message as authorized without installing any additional software on user interface device (i.e., computer).

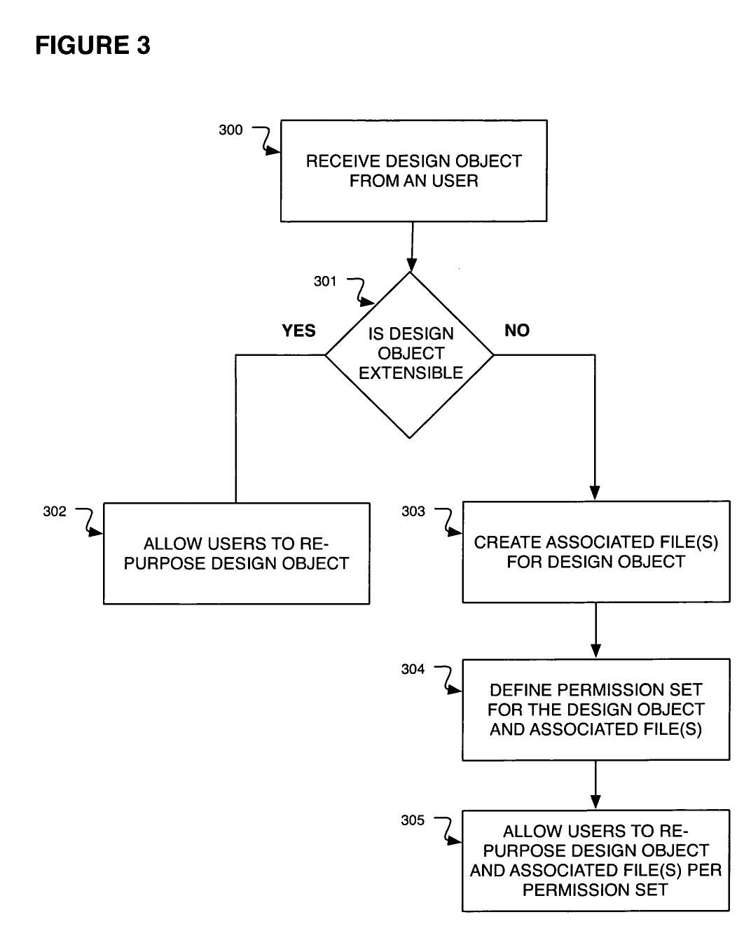

FIG. 3 illustrates process of submitting design object according to one or more embodiments of the invention. Once associated with brand imagery or messaging these design objects become brand capsules ready for dissemination by driving users. At step 300, the system receives a design object from a user for inclusion in a database of the system. At decision point 301, the system interacts with the user to determine whether the design object is reduced to extensible digital form. If the design object is reduced to extensible digital form at 302, the system allows any users to re-purpose the design object. Extensible and semi-extensible digital forms of design objects, associated files and documentation are typically stored in a database. In some embodiments of the invention, design objects received are automatically reduced into extensible digital forms and allow any user to re-purpose the design objects.

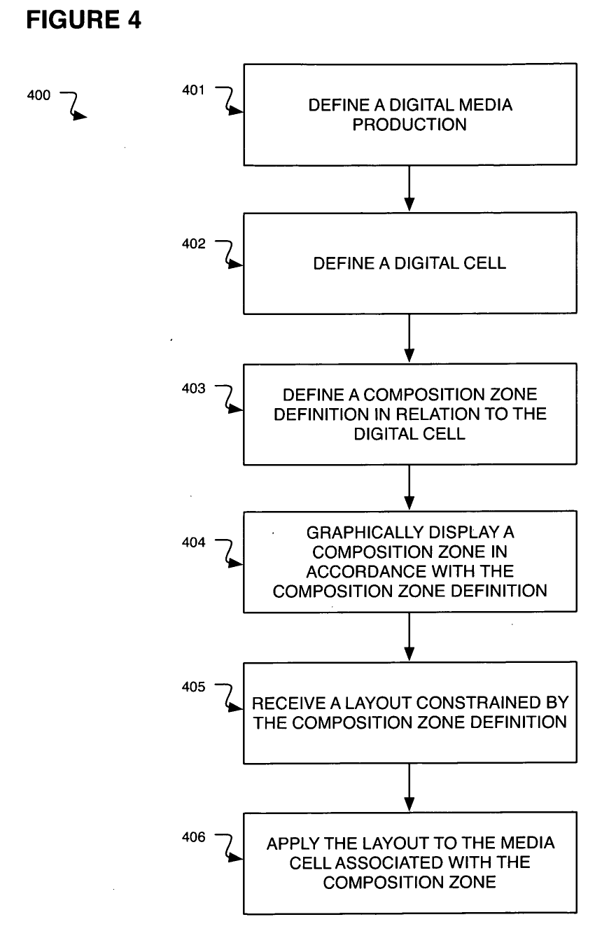

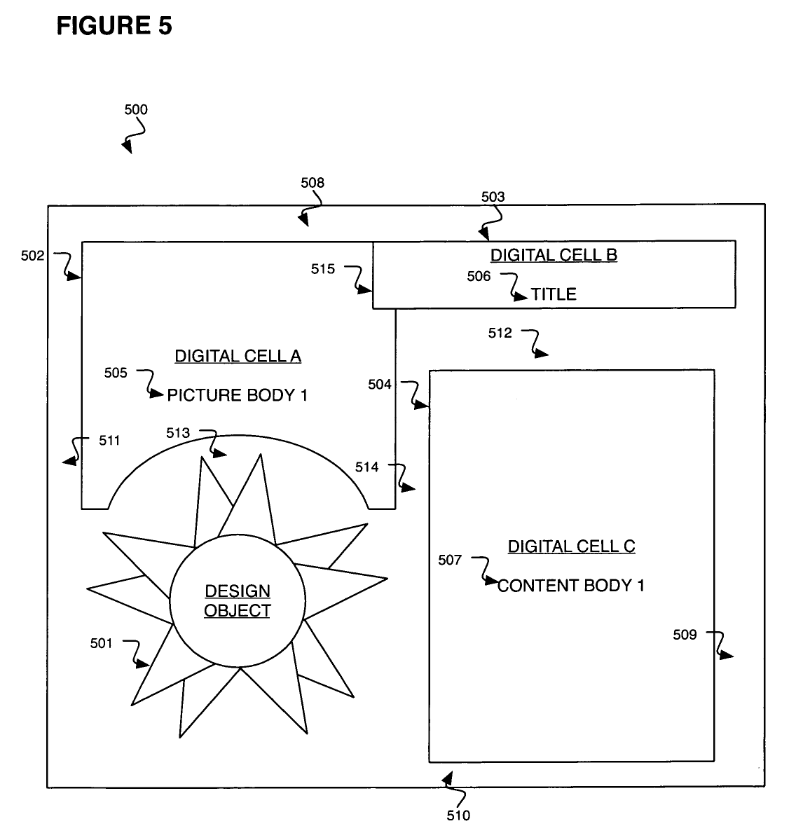

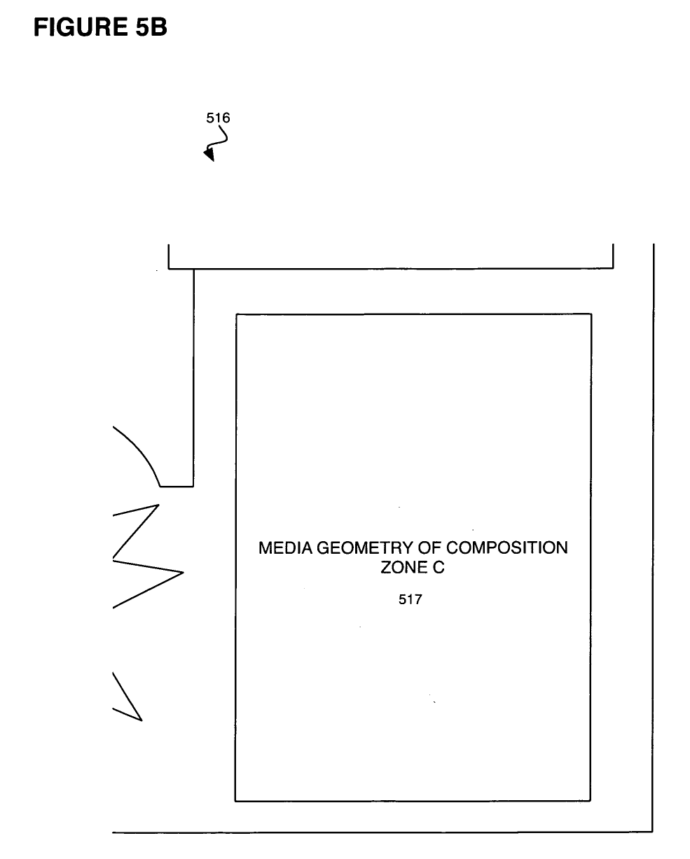

If the user indicates that the design object is not fully extensible at step 301, then at step 303 the system interacts with the user to create associated files for the design object. The associated files can include design object description, supporting documentation, digital media templates, digital cells, digital media, marketing and advertising materials, and so forth. For example, the system may automatically place design object in a particular collection according to category from the design object description. Creation of the digital media is discussed in detail with reference to FIGS. 4-5.

At step 304 the system interacts with the user to determine the permission set for this particular design object and associated files. The design object permission set can include, for example, authority for all other users to view all or only certain design objects, authority for all other users to modify digital zones or digital media templates, authority for all other users to re-purpose the design object in a limited way, and so forth. At step 305, system allows any users to access and/or modify design objects, digital cells, digital media templates, composition zones, product documentation, and associated files per design object permission set.

Turning to FIG. 4, a flow diagram 400 illustrates a method utilizing composition zones in accordance with one or more embodiments of the invention. Following flow diagram 400, a digital media production is defined (block 401). This can include, but is not limited to, providing a high level layout of a media page(s), web page(s), audio program, video program, or other media layout. One or more digital cells are defined (block 402). Such digital cells can be a portion of the defined media production. Thus, as just one example, a digital cell can be an open area where an user provided content object will be placed on a “e-postcard”. Based on the disclosure provided herein, one of ordinary skill in the art will recognize a myriad of digital cells that can be defined in accordance with one or more embodiments of the invention.

A composition zone can be defined in relation to a respective digital cell (block 403). This can include defining various parts of the composition zone including a geometry in which a design object or user content will be placed (i.e., media geometry), and in some cases context surrounding the digital cell. Such context is further described below in relation to FIGS. 5. This composition zone definition can be used to graphically display a composition zone (block 404). The graphically displayed composition zone can be used by a user or other entity to prepare a layout and/or add user content. This layout can be associated with the digital cell corresponding to the composition zone. The design created in relation to the composition zone is received (block 405), and the design is portrayed in the location associated with the digital cell of the digital media production (block 406). Further, in some cases, the layout can be checked against design limits and/or resources provided.

Turning to FIGS. 5, a digital medium in a form of “e-postcard” 500 is provided to illustrate various embodiments of the invention. Digital medium 500 can be designed by a user or another entity and can be tailored for display on one or more user interface device and/or one or more media productions. For example, digital medium 500 can be tailored for display on a printed page, on a website page, on a signature line of email, as one or more frames of a video segment, or as part of some other media production. Digital medium 500 includes three digital cells 502, 503, 504. Each of the digital cells are associated with composition zones as further described below.

In this case, page layout of digital medium 500 includes a variety of information useful for understanding the purpose of each of the digital cells. For example, digital medium 500 includes an area set aside for a digital object (in a form of brand logo in this example) 501. It is contemplated that a digital object may not be placed in the initial creation of a digital medium. Further, one or more of digital cells 502, 503, 504 can include intent information. For example, digital cell A 502 includes an indication that it is to be a picture or animated image 505. As another example, digital cell cell B 503 includes an indication that it is to be used as a title 506. As yet another example, digital cell C 504 includes an indication that it is to be used as a content body 507.

Page layout of digital medium 500 also includes a variety of definitional information. This definitional information can include, but is not limited to, outer page margins 508, 509, 510, 511. These margins can, for example, account for page trim, fold, and/or other characteristics. Other examples of definitional information includes spacing between digital cells 512, 513, 514, 514, 515. Such spacing can vary from zero to any distance, and in some cases can account for aesthetic characteristics (e.g., bleed or border).

As previously suggested, page layout of digital medium 500 may include a variety of elements and definitions that in some cases are associated with a composition zone whether they be as context or part of the media geometry of the composition zone. In some cases, the media geometry is referred to as a media box, and can be of any shape or size, but is often rectangular in shape. As just some examples, a page layout can include a variety of boundary specifications including, but not limited to, a crop box, a bleed box, and a trim box.

A bleed box defines an area that is to be clipped in the media production. This bounding box is useful to composition zones related to digital cells. For example, a composition zone that falls within all sides of a digital cell defined to be the page of a digital publication would use a trim box for its display area. If a composition zone comes in contact with one or more sides of the digital cell's trim, then the display area of that composition zone may extend to the bleed box defined for the digital cell.

A trim box defines the intended dimensions of the finished composition zone. As an example, where the composition zone encompasses an entire page of a digital publication, then the trim box defines the finished dimensions of that page after any folding and trimming. In some cases, the trim box can also indicate the default display area for a composition zone. A crop box is a clipping path that defines the display area of a composition zone. The crop box can apply to the media box, bleed box, or trim box. The crop box may use the trim box by default but can be changed to any other bounding box or path on an instance-by-instance basis.

Other examples include a binding intent that identifies the type of binding specified, and the side on which the binding is to be applied. This binding intent can in some cases impact a composition zone. For example, when two digital cells come together at the spine, a trim box associated with a composition zone near the spine the composition zone's trim box may change size to accommodate creep or binding gutter.

Based on the disclosure provided herein, one of ordinary skill in the art will recognize a variety of information that can be included to describe the intent of digital cells. Further, based on the disclosure provided herein, one of ordinary skill in the art will recognize that in some instances of the present invention no information related to the intent of a digital cell is included. Also, based on the disclosure provided herein, one of ordinary skill in the art will recognize that digital cells can be defined in a variety of shapes including straight and curved area boundaries. Further, such digital cells can be a portion of a page, the entire page, or multiple pages. As just some other examples, a digital cell can be included in a email, a digital medium or portion thereof, a website or portion thereof, a video segment, an audio segment, or the like.

Turning to FIG. 5B, digital cells 502, 503, 504 can be associated with composition zones. In particular, composition zone 516 is associated with digital cell 504. Composition zone 516 can be provided to a user or other entity responsible for the content of digital cell 504. As illustrated, composition zone 516 includes a media geometry 517 that defines the area in which the user places his design (e.g., content object or design object). In addition to media geometry 517, composition zone 516 may have a variety of context surrounding media geometry 517. Such context can be used by a user to design in relation to the areas that will be surrounding media geometry 517 when it is deployed. In some embodiments of the invention, digital cells and composition zones includes object permission set that defines whether they are user editable or any kind of allowance for content object(s) and/or design object(s) to be placed and/or be created within.

In some cases, context is completely defined when the user is preparing his layout in media geometry 517, and in other cases it only includes whatever descriptive information was available from page layout of digital medium 500 when it was originally defined. In various cases, context is synchronized to the digital cells and other areas which it represents. Thus, when another entities is preparing a design for another digital cell and/or content object surrounding media geometry 517, that design information can be updated and included in context 517 as it becomes available. Similarly, in some cases, a layout provided in relation to media geometry 517 or portion thereof can be included with the context of another composition zone associated with another digital cell. As much information about the surrounding digital cell as is available up to the completed design may be included as context. Context also can be represented by dummy or example text to assist a user in customizing digital media production.

Such system using preprogrammed computer platform could provide a user interface display of the graphic images and the ability to control those layout and content objects using predetermined graphic manipulation icon or icons. It should be noted that the high-level functions presented to the end user are being translated into a series of low-level functions, the core functions, thereby freeing the end-user from having to manipulate the image content using the low-level controls and freeing the digital media developer from having to translate the high-level functions into their low-level language.

A typical graphic application as presented by the system have a number of functions that can control various aspects of a digital production on the screen. The functions would typically include transforms such as distort, move, rotate and scaling functions in addition to object properties functions such as RBG (color), intensity and opacity. Each of these functions may be controlled by the graphic user interface device user to manipulate components of the overall digital production. It would be typical that the data manipulation functions that cause movement of the sub-components within the digital production were in some way associated with the content of the content object on an intuitive level.

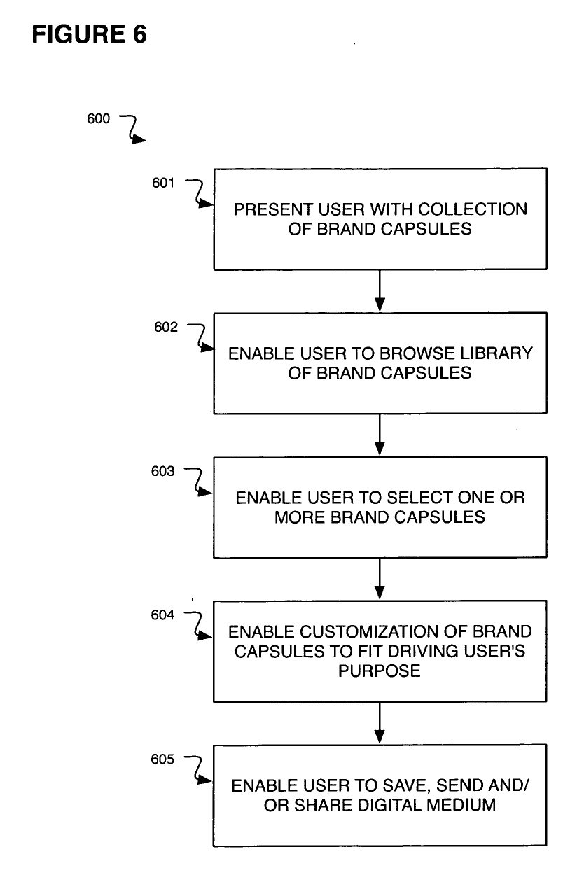

Turning to FIG. 6, a flow diagram 600 illustrates a viral advertising method of interacting with a user in accordance with one or more embodiments of the invention. Following flow diagram 600, a user is presented with a library of images of branding capsules (e.g., finalized design objects) (block 601). This can include, but is not limited to, providing a library of tiled images that automatically and randomly flip around to reveal another image. The user may browse and search for brand capsules(s) (block 602). Brand capsules can be grouped in one or more categories for selection (block 603). Enabling digital production allows user to choose a particular digital medium incorporating selected brand capsules and adding information to the brand capsule by inputting data into the digital cell(s) and/or composition zone(s) of the brand capsule (block 604). Hence each brand capsule can be customized to fit the driving user's purpose. The system supports numerous types of brand capsules and is configured to flex with the desires and use of the driving users. In general terms each brand capsule is created so that driving users can utilize the message for in connection with a personal message to a friend or group of friend, announce an event, promote an activity or solicit services from recipients of the brand capsule. In the case of brand capsule that also is to be disseminated in extensible digital form, users may utilize the system to distribute the extensible form of the brand capsule. This can include downloading design object in a file format to a storage repository coupled to the user's user interface device for the user's personal use (e.g., using available application or software tools on the user interface device to create personalized digital media).

Once the brand capsule is ready for distribution the system enables the driving user(s) to send the capsule to a set of receiving users identified by the driving users in connection with the message the driving user wishes to communication (block 605). User may also save their brand capsules on a digital medium on user account or on a storage repository or share digital medium with others individuals, for example within a social network. Sharing digital medium can include, for example, posting image on web page(s).

Some examples of various types of brand capsules contemplated by the system are provided here for purposes of illustrating how the system enables users to use brand capsules to communication is a manner that endorses specific brands in association with circumstances of the driving users choosing.

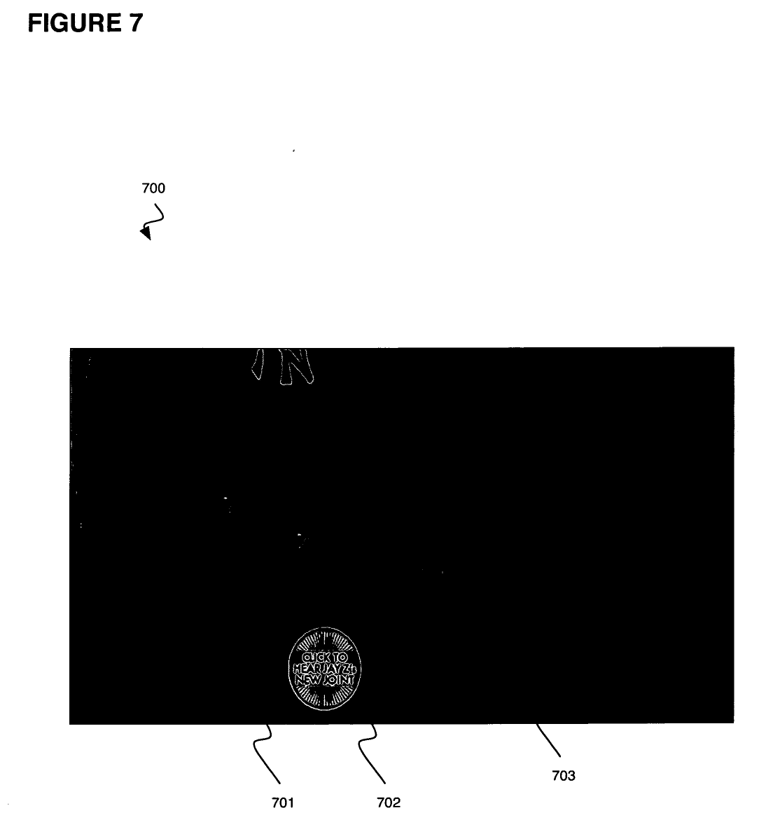

FIG. 7 illustrates a brand capsule 700 containing digital imagery 701 for promoting a new album. The brand capsule contains embedded links 702 to audio files for the album that is being promoted by the brand capsule and personally endorsed by the sender in the composition zone 703. The driving user in the example given could be the artist himself or someone wishing to promote the artist to others who are thought to be potential listeners. In addition to providing the audio file in either embedded or linked to form the brand capsule may solicit feedback or input from the user about the brand itself or in this case the new song by Jay Z 701.

FIG. 8 illustrates a brand capsule 800 that a driving user sent for purposes of inviting others to watch a basketball game at an identified location. By sending the brand capsule the driving user implicitly or explicitly endorses Nike™ 801 as a result of Nike providing a click through to basketball stats information 802. Receiving user's may reply with a status 803 as to whether or not they are going to attend.

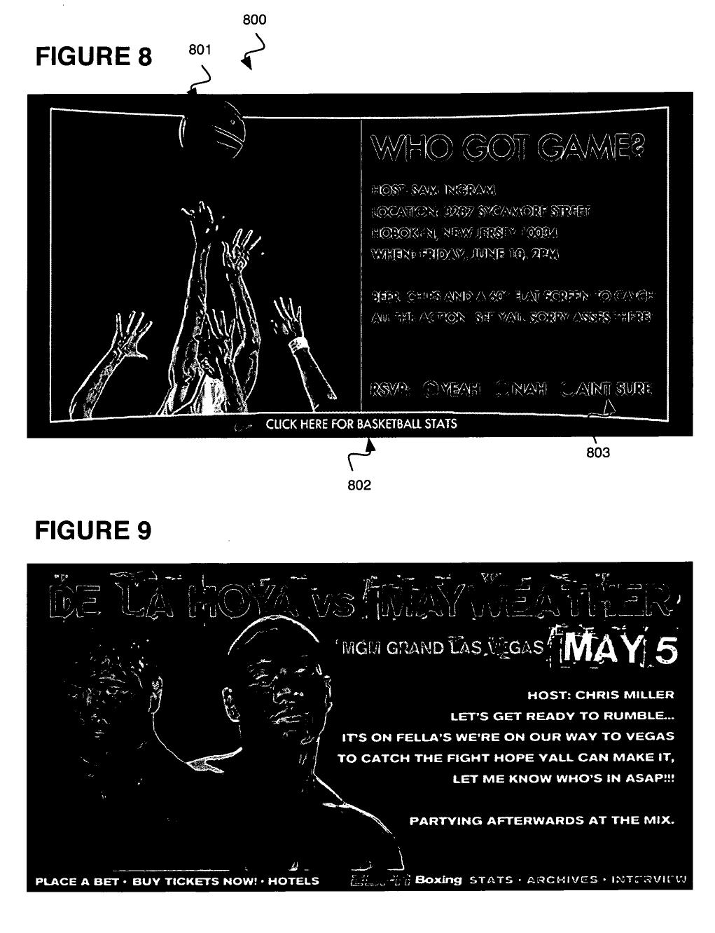

FIG. 9 illustrates a brand capsule that a driving user might send to promote attending an event such as a fight. In sending the brand capsule the driving user endorses the brands mentioned and also offers various services related to the event. Recipients may, for instance, place a bet, buy tickets, or determine what hotels are convenient to stay at. Embedded functionality for further communicating details about the event and brands relevant to the event accompanies the brand capsule. Compensation to driving users sending the brand capsule might be offered in cases where web sites that gain traffic from the referral are willing to pay for the driving user promoting links to the web sites referenced in the brand capsule. Compensation by the brands or web sites that receiving traffic as a function of the brand capsule might also be paid to the administrator of the brand capsule repository. A personalized message for encouraging people to make use of the brand capsule might be written by the driving user and provided with the brand capsule. Links to web sites or other digital documents that provide further information about the event whatever it may be are also distributed with the brand capsule. In the case where links are provided the brand capsule drivers traffic to a set of pre-determined websites. In the case where digital information relevant to the web site accompanies the brand capsule such information may be made available via a computer network such as the web or distributed with or as part of the brand capsule itself.

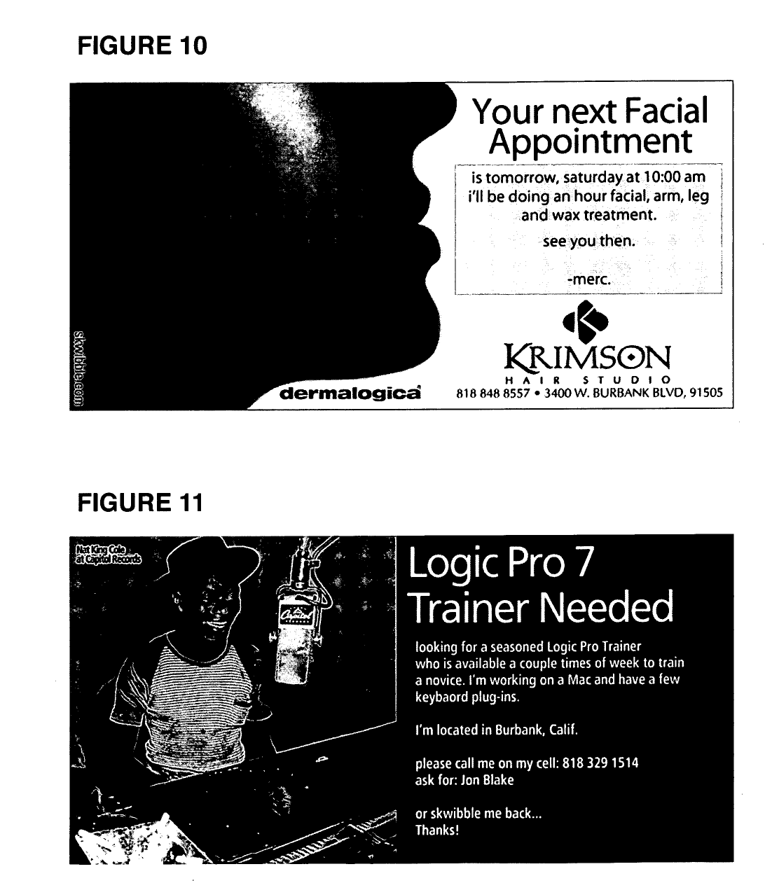

FIG. 10 illustrates a brand capsule that a driving user sends to promote a service offered by the driving user and brands affiliated with the service itself. By including reference to one or more specific brands the services provider which is in this instance is also the driving user is the service provider and the brand are implicitly associated. The brand that is endorsed by the message is generally relevant to the services offered but may also be other brands chosen by the driving user as something the driving user wishes to endorse. In cases where the service offered would benefit from a confirmation such functionality could be provided with the brand capsule and configured to send a message back to the driving user once the confirmation is given. In other instances, particularly for cases where the services referenced by the brand capsule require the person receiving the service to fill out paperwork, a digital version of the paperwork might be offered and made available for the recipient to fill out and send back to the services provider. In the case of a doctors appointment a form might be given to prospective patients along with the brand capsule and configured to permit the patient to fill out the necessary forms in advance of their doctor's appointment.

FIG. 11 illustrates a brand capsule that relates to a driving user soliciting services or expertise about a particular product, service or other matter. In the instance given the driving user has prepared a brand capsule requesting training on “Logic Pro 7” software. Where appropriate the driving user might include further information about the scope of the request and define the services requested. Explicit or implicit with the request is the driving user's endorsement or user of the item for which services are needed.

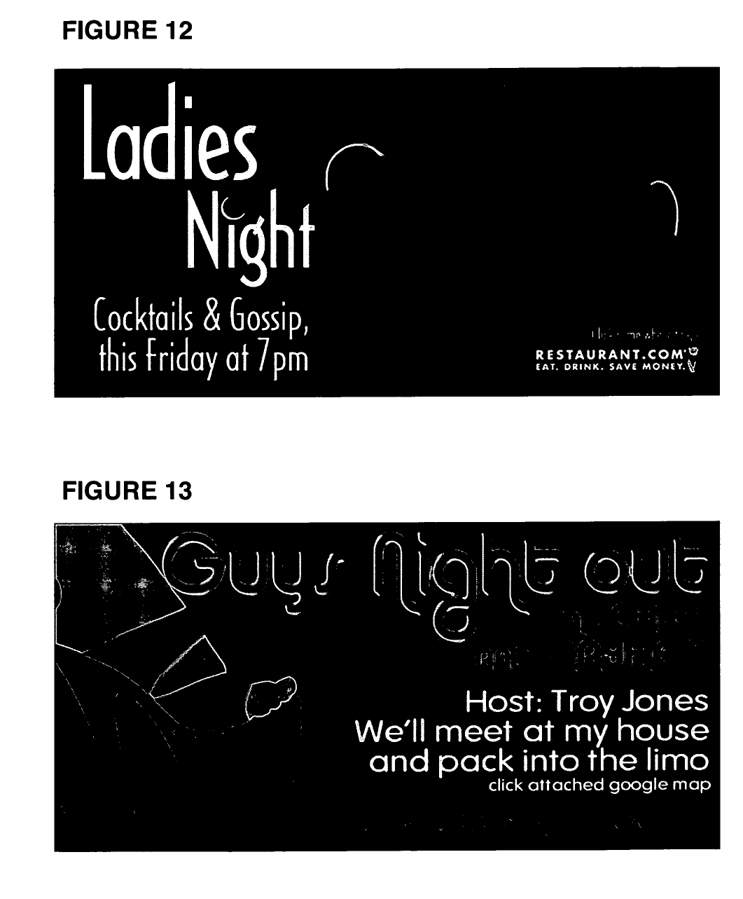

FIG. 12 illustrates a brand capsule related to an activity the driving user wishes to convey to a receiving user and invite the receiving user to attend. In the example given the driving user invites one or more receiving users out to have a drink. The brand capsule contains a link to a web site that is promoted through the brand capsule and provides functionality relevant to the anticipated event.

FIG. 13 illustrates a brand capsule that relates to an activity organized by the driving user and provides links to a web site relevant to the activity. If the activity were an invitation for lunch, for example (not depicted) the brand capsule might identify the restaurant, have links to the menu and provide recipients with special offers, discounts or a way to pre-order their meal choice and/or seating preferences. Hence the brand capsule leverages the personal endorsement by offering further services that complement or extend upon the event and the personal endorsement of the event.

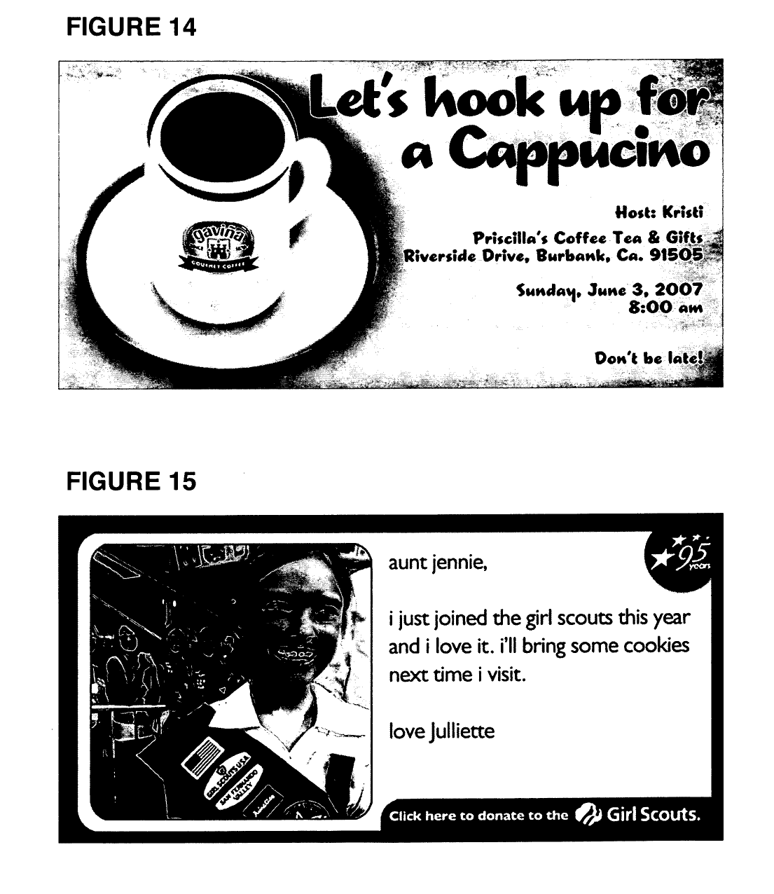

FIG. 14 illustrates a brand capsule that serves as an invitation to a meeting at a coffee house. The invitation has branding associated with it and is implicitly endorsed by the driving user by function of the driving user sending it. The brand capsule might be used to point users who click on the brand being promoted to a web site that is brand related.

FIG. 15 illustrates a brand capsule that serves as a personal note and solicitation for a charity or other organization that accepts donations. By transmitting the brand capsule driving users endorse the brand referenced in the brand capsule and also ask for donations. The personal message may be adjusted as desired by the driving user. In cases where an ongoing fundraiser is referenced in the brand capsule proceeds given as a result of the driving users brand capsule may be traced back to the driving user. If compensation is provided to the charity as a result of the receiving user visiting a web page (e.g., because certain ads were displayed and clicked on) the payment could be made to the charity but traceable back to the driving user who initiated the click.

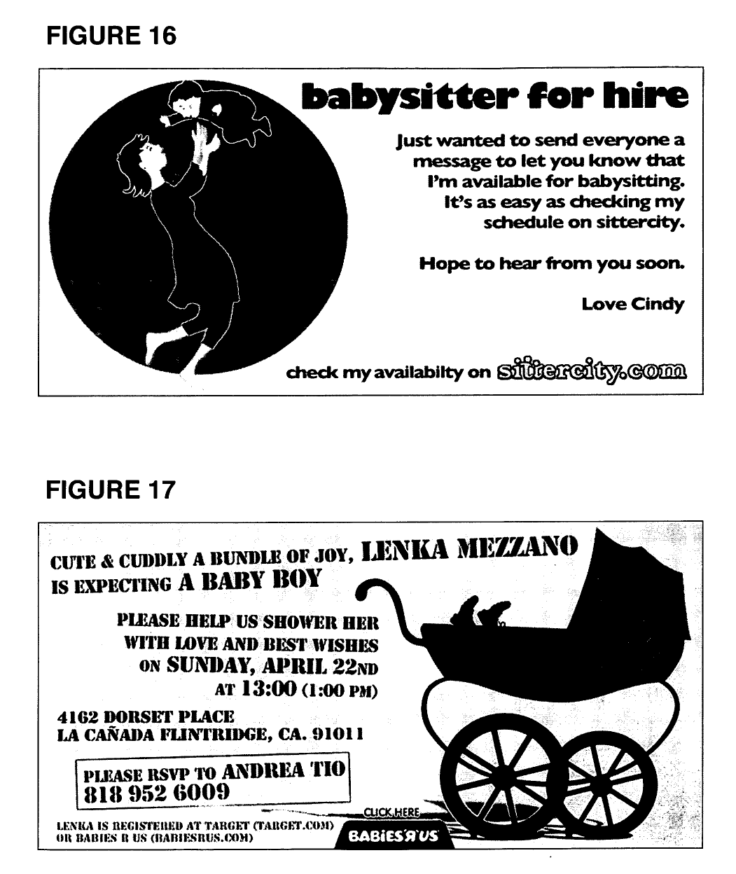

FIG. 16 illustrates a brand capsule that promotes a service offered by a driving user. In this example the brand capsule is branded by reference to a web site that is used to promote or schedule the driving user's services. Receiving users may book the driving user's services by using the functionality provided in the brand capsule.

FIG. 17 illustrates a brand capsule to an event that has a corresponding association with a commercial entity as a function of a registry. Weddings, bridal showers, baby showers and other events where a registry is appropriate may be endorsed as part of the brand capsule with functionality relating to purchase items or fractional shares of items listed on the registry.

While the invention herein disclosed has been described by means of specific embodiments and applications thereof, numerous modifications and variations could be made thereto by those skilled in the art without departing from the scope of the invention set forth in the claims.

What is claimed is:

1. A method for enabling driving users to conduct associative endorsement and distribution of branding capsules comprising:
presenting a plurality of brand capsules to a driving user for selection, said;
obtaining a selection from said driving user of at least one of said plurality of brand capsules;
obtaining customizations from said driving user where said customizations comprises information said driving user wishes to convey to a receiving user; and
disseminating said branding capsule to said receiving user.

2. The method of claim 1 wherein said plurality of branding capsules comprise digital imagery affiliated with a brand.

3. The method of claim 1 wherein said at least one brand capsule comprises embedded functionality for communicating further details about a brand associated with said at least one brand capsule to said receiving users.

4. The method of claim 1 wherein said information said driving user wishes to convey to said receiving user relates to an event.

5. The method of claim 1 wherein said information said driving user wishes to convey to said receiving user relates to a services promoted by said driving user.

6. The method of claim 1 wherein said information said driving user wishes to convey to said receiving user relates to a services needed by said driving user.

7. The method of claim 1 wherein said information said driving user wishes to convey to said receiving user relates to an activity to which said receiving user is invited by said driving user.

8. The method of claim 1 wherein said information said driving user wishes to convey to said receiving user relates to a meeting organized by said driving user.

9. The method of claim 1 wherein said information said driving user wishes to convey to said receiving user relates to a brand endorsed by said driving user.

10. The method of claim 1 wherein said information said driving user wishes to convey to said receiving user relates to a charity endorsed by said driving user.
